(19) United States
(12) Patent Application Publication
(10) Pub. No.: US 2022/0366270 A1
(43) Pub. Date: Nov. 17, 2022

(54) KNOWLEDGE GRAPH GUIDED DATABASE COMPLETION AND CORRECTION SYSTEM AND METHODS

(71) Applicant: Cherre, Inc., New York, NY (US)

(72) Inventors: Ron Bekkerman, Tenafly, NJ (US); Jeffrey Spreng, Pittsburgh, PA (US)

(73) Assignee: Cherre, Inc., New York, NY (US)

(21) Appl. No.: 17/317,699

(22) Filed: May 11, 2021

(51) Int. Cl. G06N 5/02; G06F 16/22; G06F 16/215; G06F 16/901

(52) U.S. Cl. CPC G06N 5/022; G06F 16/2282; G06F 16/221; G06F 16/215; G06F 16/9024

(57) ABSTRACT

A method includes accessing a database including a table including a first column including a first plurality of values, a second column including a second plurality of values, and a plurality of rows. A knowledge graph is constructed including a first plurality of nodes based on the first plurality of values, a second plurality of nodes based on the second plurality of values, and a plurality of node connections. A missing value is detected in the second column. A first particular value of the first plurality of values is detected in the first column. A first particular node corresponding to the first particular value is detected. The first particular node is determined to be connected to a second particular node corresponding to a second particular value of the second plurality of values, and the missing value is filled with the second particular value.

### FIELD OF INVENTION

The invention relates generally to processor-enabled database maintenance, and more particularly to processor-enabled database completion and correction.

### BACKGROUND

Databases are used extensively in the support of industrial endeavors. The maintenance of databases has a direct effect on the ability to perform scientific and industrial tasks. Particularly, errors in a database or missing values in a database may hinder the performance of industrial processes.

Computer systems need to be able to identify, store, and recall measurements in an industrial process. Computer systems in communication with each other may further need to resolve measurements, that is, to agree whether two measurements are the same or not, in order to exchange information about a particular machine or process and retain information about the machine or process without having complete information about the machine or process. When multiple computer systems or multiple sensors or components of a computer system are required to exchange data relating to a particular machine or process to facilitate an action, resolving measurements becomes more challenging. The resolving of measurements is frequently time sensitive, and delays in resolving measurements may affect the ability of an industrial process to be completed.

Computer systems in communication with each other may further need to disambiguate measurements, that is, to agree whether a measurement is conflicting with another measurement, in order to exchange information about a particular machine or process and retain information about the machine or process without having complete information about the machine or process. When multiple computer systems or multiple sensors or components of a computer system are required to exchange data relating to a particular machine or process to facilitate an action, disambiguating measurements becomes more challenging. The disambiguating of measurements is frequently time sensitive, and delays in disambiguating measurements may affect the ability of an industrial process to be completed.

Computer systems further need to be able to identify, store, and recall indications of real-world entities. Computer systems in communication with each other may further need to resolve identities of entities, that is, to agree whether two identities are the same or not, in order to exchange information about a particular entity and retain information about the particular entity without having complete information about the particular entity. When multiple computer systems in a computer network are required to exchange data relating to a particular entity to facilitate a transaction, resolving identities becomes more challenging. The resolving of identities of entities is frequently time sensitive, and delays in resolving an entity may affect the ability of a transaction to be completed.

Computer systems in communication with each other may further need to disambiguate identities of entities, that is, to agree whether a particular entity is actually two or more entities, in order to exchange information about the particular entity and retain information about the particular entity without having complete information about the particular entity. When multiple computer systems in a computer network are required to exchange data relating to a particular entity to facilitate a transaction, disambiguating entities becomes more challenging. The disambiguating of entities is frequently time sensitive, and delays in disambiguating an entity may affect the ability of a transaction to be completed.

Many industries rely on publicly sourced network-accessible data, the quality and accuracy of which is not always easily ascertained. This data may include missing, erroneous, ambiguous, and conflicting data. Correcting erroneous data, completing missing data, and resolving and disambiguating entities derived from such network-accessible data can be computationally intensive based on the volume and quality of the data. The real estate industry in particular is faced with data of varying quality from various disparate municipalities, which data is maintained at different levels of government, including for example borough, city, county, and state governments.

A knowledge graph enables organizing and analyzing knowledge in a computing environment. In a knowledge graph, entities are represented as nodes and their relationships are represented as edges connecting nodes. Attributes can be associated with both nodes and edges.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A data processing method including a database completion method is provided. The data processing method includes accessing a relational database including one or more tables including a first column including a first plurality of values, a second column including a second plurality of values, and a plurality of rows including the first plurality of values and the second plurality of values. A knowledge graph is constructed including a first plurality of nodes based on the first plurality of values, a second plurality of nodes based on the second plurality of values, and a plurality of node connections connecting the first plurality of nodes and the second plurality of nodes. A missing value is detected in a particular row in the second column in the one or more tables in the relational database. A first particular value of the first plurality of values is detected in the first column in the particular row. A first particular node corresponding to the first particular value is detected. The first particular node is determined to be connected by a first connection to a second particular node corresponding to a second particular value of the second plurality of values, and the missing value is filled with the second particular value based on the determining the first particular node is connected to the second particular node.

A further data processing method including a database correction method is provided. The further data processing method includes accessing a relational database including one or more tables including a first column including a first plurality of values, a second column including a second plurality of values, and a plurality of rows including the first plurality of values and the second plurality of values. A knowledge graph is constructed including a first plurality of nodes based on the first plurality of values, a second plurality of nodes based on the second plurality of values, and a plurality of node connections connecting the first plurality of nodes and the second plurality of nodes. An inconsistency is detected between the first plurality of values and the second plurality of values. One or more of the plurality of node connections of the knowledge graph are back-propagated into one or more of the plurality of rows of the one or more tables of the relational database to resolve the inconsistency between the first plurality of values and the second plurality of values.

A computing system is provided including one or more hardware processors and one or more non-transitory computer-readable storage media coupled to the one or more hardware processors and storing programming instructions for execution by the one or more hardware processors, wherein the programming instructions, when executed, cause the computing system to perform operations including accessing a relational database including one or more tables including a first column including a first plurality of values, a second column including a second plurality of values, and a plurality of rows including the first plurality of values and the second plurality of values. The programming instructions further cause a knowledge graph to be constructed including a first plurality of nodes based on the first plurality of values, a second plurality of nodes based on the second plurality of values, and a plurality of node connections connecting the first plurality of nodes and the second plurality of nodes. An inconsistency is detected between the first plurality of values and the second plurality of values. One or more of the plurality of node connections of the knowledge graph are back-propagated into one or more of the plurality of rows of the one or more tables of the relational database to resolve the inconsistency between the first plurality of values and the second plurality of values.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 is a diagram showing a system including a data manager for disambiguating data values according to illustrative embodiments.

FIG. 2 is a diagram showing a process flow for knowledge graph construction and use as enabled by the data manager of FIG. 1.

FIG. 3 shows exemplary tables of relational databases for visualizing methods according to illustrative embodiments.

FIGS. 4 and 5 figuratively show exemplary knowledge graphs for visualizing methods according to illustrative embodiments.

FIG. 6 is a diagram showing a method for completing a relational database.

FIGS. 7 and 8 show extensions of the method for completing a relational database of FIG. 6.

FIG. 9 is a diagram showing a method for correcting a relational database.

FIG. 10 shows an extension of the method for correcting a relational database shown in FIG. 9.

### DETAILED DESCRIPTION OF ILLUSTRATIVE EMBODIMENT(S)

Embodiments of the invention are described below with reference to the drawing figures wherein like numerals represent like elements throughout. The terms “a”, “an”, and “one” as used herein do not denote a limitation of quantity, but rather denote the presence of at least one of the referenced items.

Database completion and correction are challenging problems. A reason why these are difficult tasks is that it is not clear how to keep track of correct values in a database. In an example concerning a real estate database, a particular building identifier (hereinafter “building id”) can be associated with multiple building address values in multiple tables making it difficult to determine which building address value is correct. Further, a particular building id may have a missing value of the building address in one row of a table. Years later, another row might be added to the table in which the particular building id is associated with a building address value. Since the missing value occurred far in the past, the missing value can be hard to detect and fix. Further, a particular building id “1234567” may be associated with a building address value in one table, and in another table, another identifier “1234567” is associated with another address; however, the other identifier “1234567” is not a building id but rather a personal identifier or user identifier (e.g., a driver license number) which was erroneously entered as a building id value. These types of situations makes the task of database completion and correction tedious and error prone. It should be understood that the herein described processes and systems can apply to any data value type and are not limited to processes and systems concerning data values including building ids and building addresses.

A knowledge graph as described herein provides part of a technological solution to database completion and correction problems. Since nodes in knowledge graphs represent entities, rather than values in databases (which values may be missing, duplicated, clashing, and contradictory), a knowledge graph can be applied to automatically resolve inconsistencies of a database. If the same entity occurs in multiple rows of multiple tables in a database, the entity can still be represented as one node in a knowledge graph. If two entities of two different types happen to have the same identifier in a database, they can be represented as two different nodes in a knowledge graph. If a connection is made between two entities in one of the database tables in a database, the connection will be propagated into the knowledge graph as an edge, so the connection will not be lost even if the connection was made in the distant past. Multiple contradictory connections in a knowledge graph can be efficiently resolved based on connection strengths.

During construction of a knowledge graph based on an input database, pointers can be stored to rows of tables of the input database from which the nodes and edges were originated. Once the knowledge graph is constructed, the input database can be quickly completed and corrected by following those pointers back to the database table rows. The resulting system is effective and efficient in completing and correcting databases.

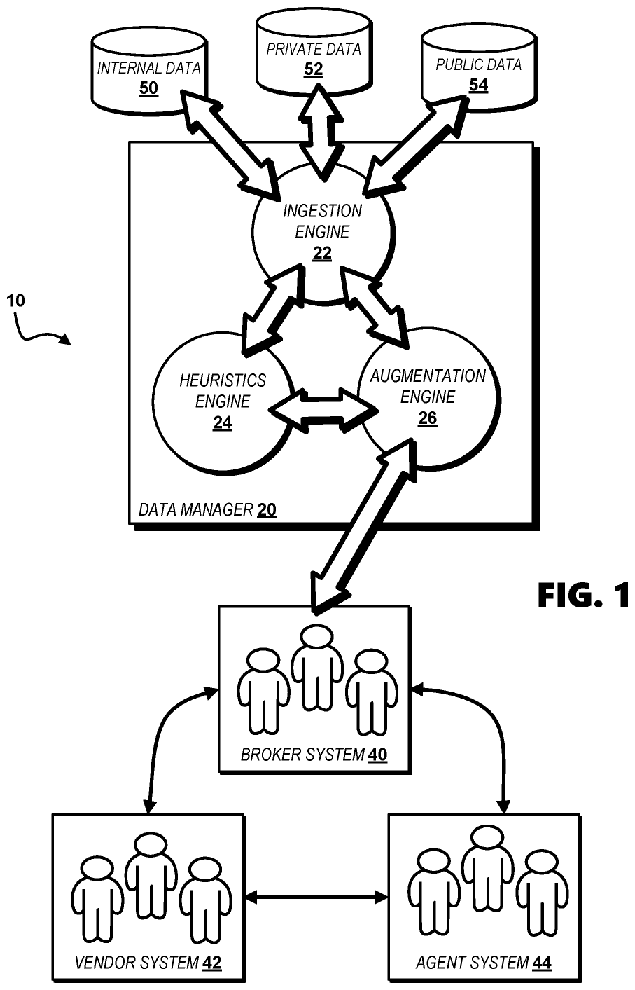

Referring to FIG. 1, a system 10 for completing and correcting databases and for disambiguating identities of entities in databases is provided. The system 10 is provided in a communications network including one or more wired or wireless networks or a combination thereof, for example including a local area network (LAN), a wide area network (WAN), the internet, mobile telephone networks, and wireless data networks such as Wi-Fi™ and 3G/4G/5G cellular networks. The system 10 includes a network-accessible processor-enabled data manager 20 used in accessing data stores of varied identifying information and technical data, including for example data stores 50, 52, 54. The data manager 20 is accessible by client computer systems 40, 42, 44. While the operation of the data manager 20 is described herein with respect to network-connectable client computer systems 40, 42, 44 and data stores 50, 52, 54, one skilled in the art will recognize that the data manager 20 can operate with other suitable wired or wireless network-connectable computing systems. The data manager 20 includes an ingestion engine 22, a heuristics engine 24, and an augmentation engine 26. The data manager 20 can be implemented on one or more network-connectable processor-enabled computing systems. The data manager 20 need not be implemented on a single system at a single location, but can be implemented on a single system at one location or multiple systems at one or more locations, for example in a peer-to-peer configuration. The data manager 20 is configured for communication via a communications network with the network-connectable client computing systems 40, 42, 44 which are identified for exemplary purposes as a broker system 40, a vendor system 42, and an agent system 44. The data manager 20 has further access to an internal data store 50, a private data store 52, and a public data store 54, which are beneficially accessible via network communication.

The data manager 20 enables the acquiring, collecting, and analyzing of network-located data in real-time. The data manager 20 can be implemented for example to collect and analyze non-public and public real estate data, which data can be rendered accessible to real estate brokers, vendors, and agents respectively via the broker system 40, the vendor system 42, and the agent system 44. Alternatively, the data manager 20 can be implemented to collect and analyze other public or non-public data, for example industrial process data such as process measurement data.

The data manager 20 via the ingestion engine 22, heuristics engine 24, and augmentation engine 26 enables construction and maintenance of relational databases and knowledge graphs in which entities are for example real estate properties, addresses, people, and companies that operate in the real estate domain. Alternatively, the data manager 20 can enable construction and maintenance of relational databases and knowledge graphs including other types of entities or data, for example industrial process data. A knowledge graph is particularly useful for revealing hidden relationships between node connections) between the nodes.

Relational databases and knowledge graphs are constructed by the data manager 20, from a variety of data sources, both structured (such as a relational database) and unstructured (such as a repository of documents). Those input data sources, for example the internal data store 50, the private data store 52, and the public data store 54, may be incomplete and inaccurate. For example, consider a table in a relational database of a real estate management company. This table may include a column named “building id” (i.e., building identifier) and a column named “building address”. In most cases, a particular building identifier is likely to be associated with a building address, that is, both building id value and building address value would be filled in at a particular row of a particular table in the database. In some cases, however, the building address value may be missing which suggests that the address of a particular building is unknown. In other cases, the building address value may be incorrect, wherein a particular building is associated with an incorrected building address.

The data manager 20 is particularly useful in completing and correcting structured input data sources (e.g., relational databases). Relational databases are used in a variety of business applications, such as accounting, reporting, and ad hoc analytics. Completeness and correctness of a relational database are mission-critical for many businesses in commercial and industrial settings.

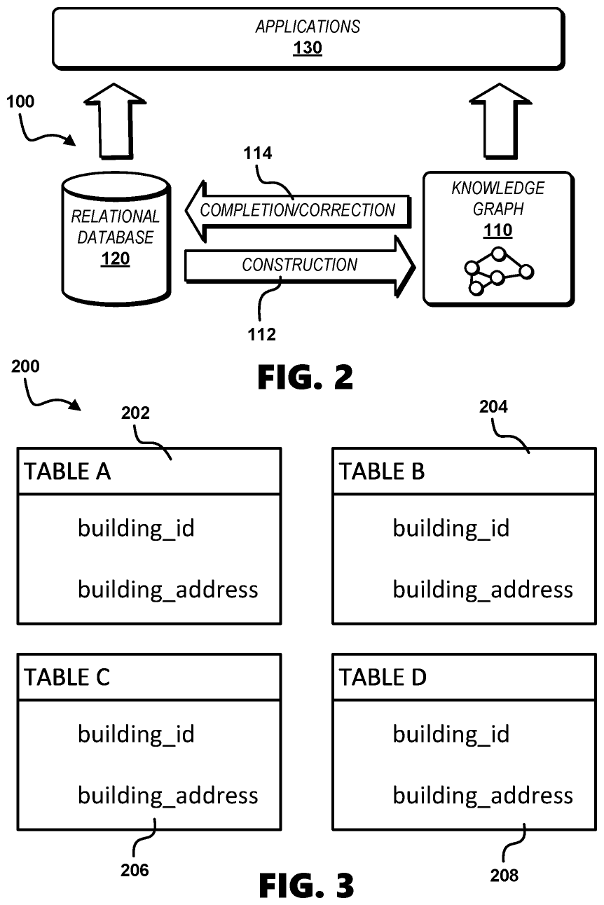

Referring to FIG. 2, a diagram shows a process flow 100 for knowledge graph construction and use, as enabled by the data manager 20 of FIG. 1 via the ingestion engine 22, heuristics engine 24, and augmentation engine 26. In the process flow 100, a knowledge graph 110 is constructed via a construction process 112 based on a relational database 120, for example stored in one of the internal data store 50, private datastore 52, or public data store 54. The relational database 120 from time to time or in real-time is completed and corrected via a completion and correction processes 114. Data from the knowledge graph 110 or the relational database 120 can be accessed by applications 130, which applications 130 can be rendered accessible by the data manager 20 to external systems, for example the broker system 40, vendor system 42, and agent system 44.

A knowledge graph can be constructed from multiple tables of a relational database. A value missing in a particular table may not be missing in other tables. When the knowledge graph is constructed, the missing value from a particular table can be propagated into the knowledge graph from another table, which value is then ready to be back-propagated into the database to fill the gap in the particular table as described in methods herein.

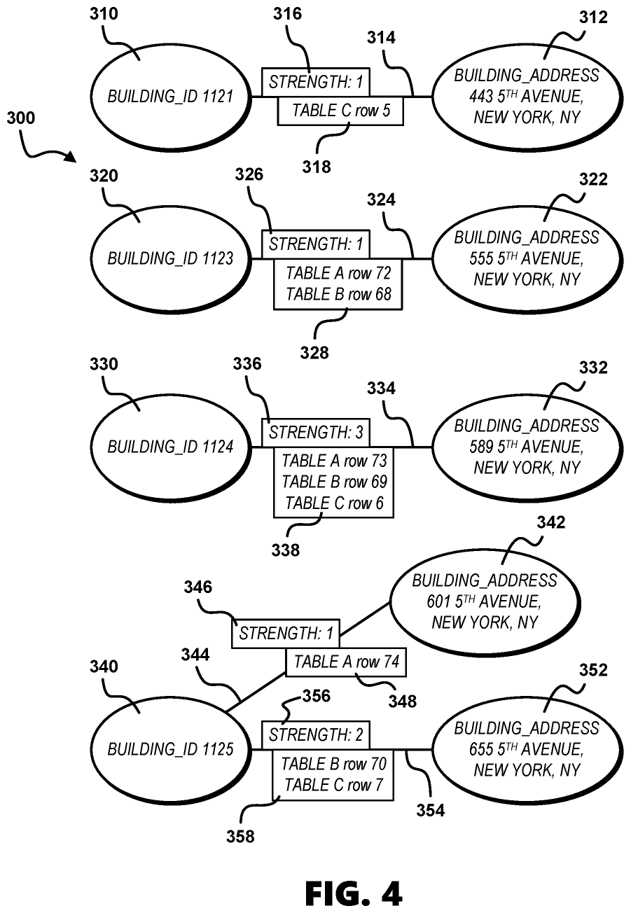

Referring to FIG. 3 a plurality of exemplary tables 200 including table A 202, table B 204, table C 206, and table D 208 are figuratively shown. Any or all of the tables 202, 204, 206, 208 can be included in a particular relational database. Each table includes a column named “building id” and a column named “building address”, exemplary values of which are listed hereinafter.

TABLE A

| row# | building id | building address |
|---|---|---|
| . . . | . . . | . . . |
| 72 | 1123 | null |
| 73 | 1124 | 589 5th Avenue, New York, NY |
| 74 | 1125 | 601 5th Avenue, New York, NY |
| . . . | . . . | . . . |

TABLE B

| row# | building id | building address |
|---|---|---|
| . . . | . . . | . . . |
| 68 | 1123 | 555 5th Avenue, New York, NY |
| 69 | 1124 | 589 5th Avenue, New York, NY |
| 70 | 1125 | 655 5th Avenue, New York, NY |
| . . . | . . . | . . . |

TABLE C

| row# | building id | building address |
|---|---|---|
| . . . | . . . | . . . |
| 5 | 1121 | 443 5^{th} Avenue, New York, NY |
| 6 | 1124 | 589 5^{th} Avenue, New York, NY |
| 7 | 1125 | 655 5th Avenue, New York, NY |
| . . . | . . . | . . . |

TABLE D

| row# | building id | building address |
|---|---|---|
| . . . | . . . | . . . |
| 86 | 1234 | 755 5th Avenue, New York, NY |
| 87 | 1234 | 755 5th Avenue, New York, NY |
| 88 | 1234 | 760 5th Avenue, New York, NY |
| 89 | 1234 | Null |
| 90 | 1239 | 768 5th Avenue, New York, NY |
| 91 | 1242 | 772 5th Avenue, New York, NY |
| . . . | . . . | . . . |

For example, a relational database can exist which includes the table A 202, table B 204, and table C 206. Referring to FIG. 4, a knowledge graph 300 is shown as constructed by the data manager 20 based on the table A 202, table B 204, and table C 206 in which nodes and edges (i.e., node connections) are created. A first node 310 including a building id 1121 is connected to a second node 312 including the address 443 5th Avenue, New York, N.Y. via a first edge 314. The first edge 314 includes a first strength label 316 including a value of one (1) based on the existence of only one (1) instance of the building id 1121 being associated with the building address 443 5th Avenue, New York, N.Y. in any of the table A 202, table B 204, and table C 206. The first edge 314 includes a first pointer label 318 including a reference to table C 206 at row 5 indicating that building id 1121 and building address 443 5th Avenue, New York, N.Y. are found only in table C 206 at row 5 of table C 206.

A third node 320 including the building id 1123 is connected to a fourth node 322 including the building address 555 5th Avenue, New York, N.Y. via a second edge 324. The second edge 324 includes a second strength label 326 including a value of one (1) based on the existence of only one (1) instance of the building id 1123 being associated with the building address 555 5th Avenue, New York, N.Y. in any of the table A 202, table B 204, and table C 206. The second edge 324 includes a second pointer label 328 including references to the table A 202 at row 72 and table B 204 at row 68 indicating that the building id 1123 or the building address 555 5th Avenue, New York, N.Y. is found in the table A 202 at row 72 and table B 204 row 68.

A fifth node 330 including the building id 1124 is connected to a sixth node 332 including the building address 589 5th Avenue, New York, N.Y. via a third edge 334. The third edge 334 includes a third strength label 336 including a value of three (3) based on the existence of three (3) instances of the building id 1124 being associated with the building address 589 5th Avenue, New York, N.Y. in any of the table A 202, table B 204, and table C 206. The third edge 334 includes a third pointer label 338 including references to the table A 202 at row 73, table B 204 at row 69, and table C 206 at row 6 indicating that the building id 1124 or the building address 589 5th Avenue, New York, N.Y. is found in the table A 202 at row 73, table B 204 at row 69, and table C 206 at row 6.

A seventh node 340 including the building id 1125 is connected to an eighth node 342 including the building address 601 5th Avenue, New York, N.Y. via a fourth edge 344. The fourth edge 344 includes a fourth strength label 346 including a value of one (1) based on the existence of only one (1) instance of the building id 1125 being associated with the building address 601 5th Avenue, New York, N.Y. in in any of the table A 202, table B 204, and table C 206. The fourth edge 344 includes a fourth pointer label 348 including a reference to the table A 202 indicating that the building id 1125 and the building address 601 5th Avenue, New York, N.Y. is found in the table A 202 at row 74.

The seventh node 340 including the building id 1125 is further connected to a ninth node 352 including the address 655 5th Avenue, New York, N.Y. via a fifth edge 354. The fifth edge 354 includes a fifth strength label 356 including a value of two (2) based on the existence of two (2) instances of the building id 1125 being associated with the building address 655 5th Avenue, New York, N.Y. in any of the table A 202, table B 204, and table C 206. The fifth edge 354 includes a fifth pointer label 358 including references to the table B 204 at row 70 and table C 206 at row 7 indicating that the building id 1125 or the building address 655 5th Avenue, New York, N.Y. is found in the table B 204 at row 70 and table C 206 at row 7.

In table A 202 the building address value of building id 1123 is missing. However, in table B, the building address value of building id 1123 is 555 5th Avenue, New York, N.Y. As described herein, the third node 320 is created for the building id 1123 and the fourth node 322 is created for the building address 555 5th Avenue, New York, N.Y. Based on the input from table B, the second edge 324 between the third node 320 for the building id 1123 and the fourth node 322 for the building address 555 5th Avenue, New York, N.Y. is created, so that the building id 1123 and the building address 555 5th Avenue, New York, N.Y. are associated with each other. This information can be propagated back to the database including the table A 202, table B 204, and table C 206, to complete the table A 202. The value of the building address for the building id 1123 is missing in table A, but a connection between the building id 1123 and the building address 555 5th Avenue, New York, N.Y. exists in the knowledge graph 300 via the third node 320 and the fourth node 322. The data manager 20 can locate the building id 1123 in the knowledge graph 300 via the third node 320, and check its neighboring nodes which includes the fourth node 322. Since the fourth node 322 includes a building address type, its value, 555 5th Avenue, New York, N.Y., can be written in table A 202 at row 72 in the building address cell associated with building id 1123.

A created knowledge graph has arbitrage powers over each table in the database from which it was created. The knowledge graph can be constructed based on multiple tables, some of which may be in agreement with each other over specific values, while others may disagree. In many cases the number of values in agreement may be greater than the number of values in disagreement in the knowledge graph, reflecting stronger agreement than disagreement, and this circumstance can be used as the basis for fixing errors in the tables.

Referring further for example to FIGS. 3 and 4, a relational database includes the herein listed table A 202, table B 204, and table C 206, each of which include a column named building id and a column named building address. In the table A 202 the building address value of the building id 1125 is 601 5th Avenue, New York, N.Y. However, in the tables B and C the building address value of building id 1125 is 655 5th Avenue, New York, N.Y.

When the knowledge graph 300 is constructed, the seventh node 340 is created for building id 1125, the eighth node 342 is created for the building address 601 5th Avenue, New York, N.Y., and the ninth node 352 is created for the building address 655 5th Avenue, New York, N.Y. Based on the input from the table A 202, the fourth edge 344 is created between the seventh node 340 of the building id 1125 and the eighth node 342 of the building address 601 5th Avenue, New York, N.Y., which fourth edge 344 can be associated with a connection strength of 1 because the connection is present in one table. Based on the input from the table B 204 and table C 206, the fifth edge 354 is created between the seventh node 340 of the building id 1125 and the ninth node 352 of the building address 655 5th Avenue, New York, N.Y., which fifth edge 354 can be associated with a connection strength of 2 because the connection is present in two tables. Alternatively, the connection strength can be a more complex function that takes into account the trustworthiness of input tables and other factors.

Particular data value nodes connected to multiple other data value nodes in a knowledge graph can be programmatically analyzed, and a conclusion can be made about whether or not the multiple other data values are referring to the same particular data value. For example, building id nodes connected to multiple building address nodes in a knowledge graph can be programmatically analyzed, and a conclusion can be made about whether or not the multiple building addresses are referring to the same building id. This can be performed for example using an algorithm which determines that certain abbreviated terms are substantially identical to their unabbreviated counterparts (e.g., “Ave” for “Avenue” or “J.” for “John”) or common alternative spellings (e.g., John for Jonathan).

If a particular building id is determined to refer to two or more different building address values, the building address corresponding to the edge with the highest connection strength can be considered as the correct building address. For example, referring to FIG. 4, the connection strength of fifth edge 354 is two (2), corresponding to 655 5th Avenue, New York, N.Y., and the connection strength of fourth edge 344 is one (1), corresponding to 601 5th Avenue, New York, N.Y. The connection strengths of the fifth edge 354 and fourth edge 344 are compared. It is determined that the correct building address of the building id 1125 is 655 5^{th} Avenue, New York, N.Y. based on the higher connection strength of the fifth edge 354 as compared to the fourth edge 344. The building address 601 5^{th} Avenue, New York, N.Y. is determined to be an incorrect address based on the lower connection strength of the fourth edge 344 relative to the fifth edge 354. This information can now be propagated back to the database, to correct table A 202. Particularly, the value of the building address for the building id 1125 can be changed to 655 5th Avenue, New York, N.Y. in table A 202.

In both the completeness and the correctness use cases described herein, the connection between nodes representing entities in a knowledge graph is not required to originate from multiple tables. Connections in a knowledge graph can be based on one table of a particular database, and actions to complete or correct particular data in the one table can be performed based on other data of the one table.

To continue the example of building id and building address columns, the value of a particular building id may occur in multiple rows of a particular table. In the majority of those rows the building address value may be a first particular value. In one or more rows, however, the building address value may be missing or incorrect. The processes described herein can be applied to complete or correct the value of building address for the particular building id, even if the correct value propagated to the knowledge graph originates from the same table. In a hybrid application, the correct value and incorrect or missing value may originate in the same table and other tables.

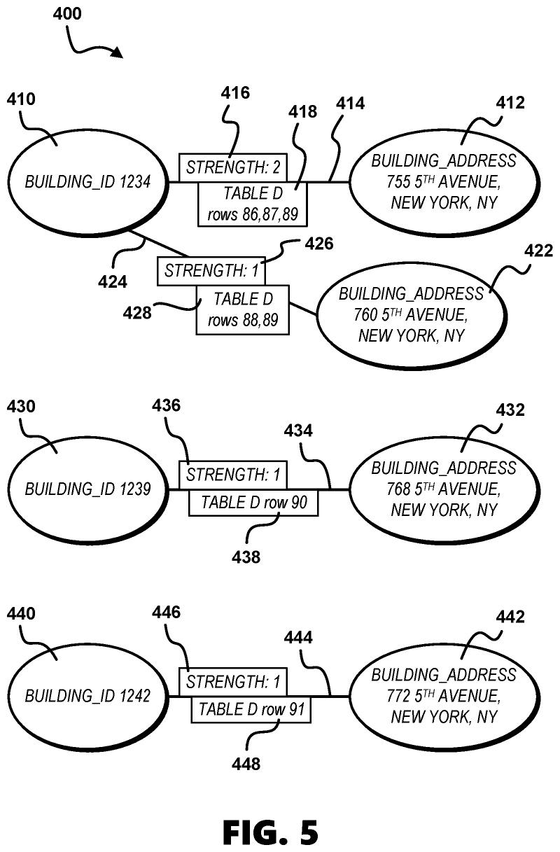

For example, a relational database can exist which includes table D 208 exclusive from or in addition to the table A 202, table B 204, and table C 206. Referring to FIG. 5, a knowledge graph 400 is constructed by the data manager 20 based on the table D 208 in which nodes and edges are created, for example separate from or integrated with the knowledge graph 300 of FIG. 4. A tenth node 410 including the building id 1234 is connected to an eleventh node 412 including the building address 755 5th Avenue, New York, N.Y. via a sixth edge 414. The sixth edge 414 includes a sixth strength label 416 including a value of two (2) based on the existence of two (2) instances of the building id 1234 being associated with the building address 755 5th Avenue, New York, N.Y. in the table D 208. The sixth edge 414 includes a sixth pointer label 418 including a reference to the table D 208 at rows 86, 87, and 89 indicating that the building id 1234 and the building address 755 5th Avenue, New York, N.Y. are found only in table D 208 at one or more of rows 86, 87, and 89.

The tenth node 410 including the building id 1234 is further connected to a twelfth node 422 including the address 760 5th Avenue, New York, N.Y. via a seventh edge 424. The seventh edge 424 includes a seventh strength label 426 including a value of one (1) based on the existence of one (1) instance of the building id 1234 being associated with building address 760 5th Avenue, New York, N.Y. in the table D 208. The seventh edge 424 includes a seventh pointer label 428 including a reference to the table D 208 at rows 88 and 89 indicating that the building id 1234 and the building address 760 5th Avenue, New York, N.Y. are found only in table D 208 at one or both of rows 88 and 89.

A thirteenth node 430 including the building id 1239 is connected to a fourteenth node 432 including the address 768 5th Avenue, New York, N.Y. via an eighth edge 434. The eighth edge 434 includes an eighth strength label 436 including a value of one (1) based on the existence of one (1) instance of the building id 1239 being associated with the building address 768 5th Avenue, New York, N.Y. in the table D 208. The eighth edge 434 includes an eighth pointer label 438 including a reference to the table D 208 at row 90 indicating that building id 1239 and the building address 768 5th Avenue, New York, N.Y. are found only in table D 208 at row 90.

A fifteenth node 440 including the building id 1242 is connected to a sixteenth node 442 including the address 772 5th Avenue, New York, N.Y. via a ninth edge 444. The ninth edge 444 includes a ninth strength label 446 including a value of one (1) based on the existence of one (1) instance of the building id 1242 being associated with the building address 772 5th Avenue, New York, N.Y. in the table D 208. The ninth edge 444 includes a ninth pointer label 448 including a reference to the table D 208 at row 91 indicating that building id 1242 and the building address 772 5th Avenue, New York, N.Y. are found only in table D 208 at row 91.

In the exemplary table D 208, in the building id and building address columns, the value 1234 of building id occurs in multiple rows. In the majority of those rows the building address value is 755 5th Avenue, New York, N.Y. In one row, however, the building address value is missing (“Null”), and in one row the building address value is incorrect. Referring to the knowledge graph 400 of FIG. 5, the sixth strength label 416 of the sixth edge 414 is compared with the seventh strength label 426 of the seventh edge 424 to determine that the sixth edge 414 corresponding to 755 5th Avenue, New York, N.Y. is stronger than the seventh edge 424 corresponding to 760 5th Avenue, New York, N.Y. The row 88 in table D 208 including the building address value of 760 5th Avenue, New York, N.Y. and the building id value of 1234 is corrected to replace the building address value with 755 5th Avenue, New York, N.Y. based on the greater strength of the sixth edge 414 relative to the seventh edge 424. Further, the row 89 in table D including the null building address value and the building id value of 1234 is filled to add the building address value of 755 5th Avenue, New York, N.Y. based on the greater strength of the sixth edge 414 relative to the seventh edge 424. If other tables exist with rows including the building id value of 1234 with null or incorrect values, such rows can be completed or corrected with the building address value of 755 5th Avenue, New York, N.Y. If other tables exist with rows including the building id value of 1234 with address value of 755 5th Avenue, this can increase the connection strength of the sixth edge 414. Conversely, if other tables exist with rows including the building id value of 1234 with address value of 760 5th Avenue this can increase the connection strength of the seventh edge 424, potentially to the extent that the seventh edge 424 would be the strongest edge, and 760 5th Avenue would be the address used in completing and correcting the database tables.

The methods described herein enable fast and efficient completion and correction of database tables to improve the functioning of a computer and to reflect improvement to various technologies and technical fields not limited to resolving names building ids and addresses. For instance, in microprocessor fabrication, manufacturing tests are applied to the fabricated microprocessor using automatic test equipment (“ATE”) which is able to collect diagnostic information for further analysis and failure resolution. The diagnostic information can be stored in a relational database. In case of a failure in a component of a fabricated microprocessor, the component's behavior may be unpredictable. Therefore, the diagnostic information (e.g., measurements) that is collected on the fabricated microprocessor by the ATE may be inconsistent and unreliable. Particularly, some of the diagnostic information may be incorrect and some of the diagnostic information may be missing. Reliability of the collected diagnostic information is difficult to assess. If errors or gaps in the diagnostic information are not detected and corrected, erroneous conclusions may be made based on the diagnostic information and failures or defects in the fabricated microprocessors may remain unresolved. Moreover, in instances where thousands of microprocessors must be fabricated and tested simultaneously, delays in resolving failures can seriously hinder speed of production. Diagnostic information is typically collected from multiple components of the fabricated microprocessor, separately and aggregately. The collected diagnostic information can be redundant so that it can be used to fill up the gaps and correct the errors according to the herein described methods. The herein described methods can serve the goal of filling up gaps and correcting errors in a relational database including microprocessor diagnostic information, leading to resolving microprocessor failures.

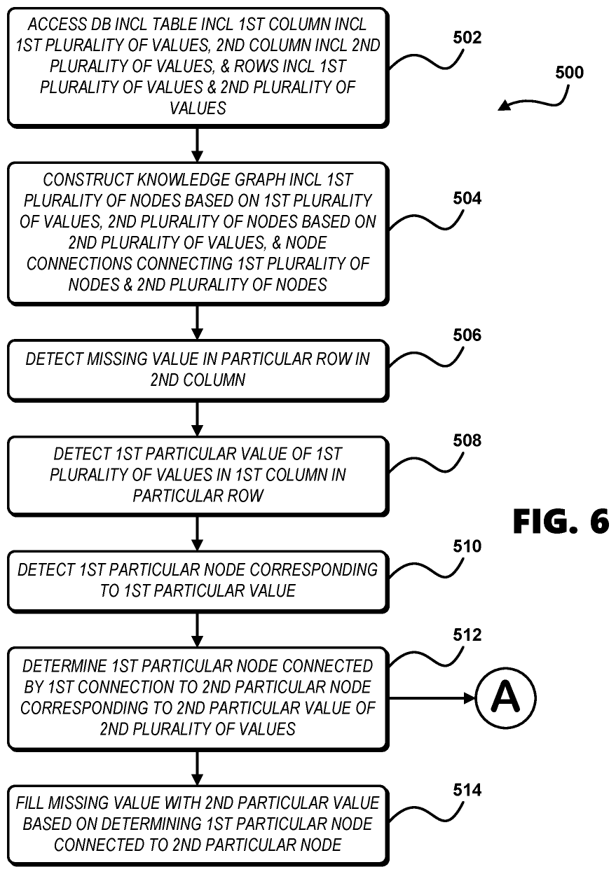

Referring to FIGS. 6, a diagram shows a data processing method in the form of a database completion method 500. The database completion method 500 is described with reference to the components of system 10 shown in FIG. 1, and the method 500 can be performed by the data manager 20 via the ingestion engine 22, heuristics engine 24, and augmentation engine 26 of the system 10. Alternatively, the method 500 can be performed via other suitable systems.

A step 502 includes accessing a relational database including one or more tables including a first column including a first plurality of values, a second column including a second plurality of values, and a plurality of rows including the first plurality of values and the second plurality of values. A knowledge graph is constructed including a first plurality of nodes based on the first plurality of values, a second plurality of nodes based on the second plurality of values, and a plurality of node connections connecting the first plurality of nodes and the second plurality of nodes (step 504). A missing value is detected in a particular row in the second column in the one or more tables in the relational database (step 506). A first particular value of the first plurality of values is detected in the first column in the particular row (step 508). A first particular node corresponding to the first particular value is detected (step 510). The first particular node is determined to be connected by a first connection to a second particular node corresponding to a second particular value of the second plurality of values (step 512), and the missing value is filled with the second particular value based on the determining the first particular node is connected to the second particular node (step 514).

In the knowledge graph constructed at step 504, each of the first plurality of nodes can include one of the first plurality of values and each of the second plurality of nodes can include one of the second plurality of values, and one or more of the first plurality of nodes corresponding to one or more rows of the one or more tables can be connected by a corresponding edge to a corresponding one of the second plurality of nodes corresponding to the one or more rows to construct the knowledge graph.

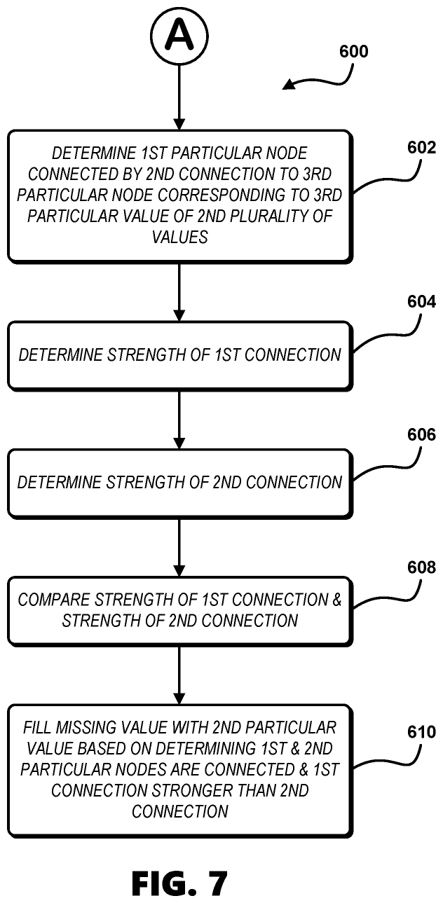

Referring to FIG. 7, an extension 600 to the method 500 continues from step 512 via connector “A” of the method 500. The method extension 600 includes determining the first particular node is connected by a second connection to a third particular node corresponding to a third particular value of the second plurality of values (step 602), determining a strength of the first connection (step 604), determining a strength of the second connection (step 606), comparing the strength of the first connection and the strength of the second connection to determine that the first connection is stronger than the second connection (step 608), and filling the missing value with the second particular value based on the determining the first particular node is connected to the second particular node as in step 514 and further based on the determining that the first connection is stronger than the second connection (step 610).

In the method extension 600, a first number of rows in the relational database supporting the first connection can be determined, a second number of rows in the relational database supporting the second connection can be determined, the strength of the first connection can be determined based on the first number of rows in the relational database supporting the first connection, and the strength of the second connection can be determined based on the second number of rows in the relational database supporting the second connection. The one or more tables can include a first table and a second table, each of the first table and the second table including a corresponding first plurality of values and a corresponding second plurality of values, wherein the first plurality of nodes of the knowledge graph are based on the first plurality of values of the first table and the first plurality of values of the second table, the second plurality of nodes of the knowledge graph are based on the second plurality of values of the first table and the second plurality of values of the second table, the first particular value of the first plurality of values is located on the first table and the second table, the second particular value of the second plurality of values is located on the first table, and the third particular value of the second plurality of values is located on the second table.

Further, the method extension 600 can include determining a first number of rows including the first particular value and the second particular value in the relational database, determining a second number of rows including the first particular value and the third particular value in the relational database, determining the strength of the first connection based on the first number of rows including the first particular value and the second particular value in the relational database, and determining the strength of the second connection based on the second number of rows including the first particular value and the third particular value in the relational database. The one or more tables can include a first table and a second table, each of the first table and the second table including a corresponding first plurality of values and a corresponding second plurality of values, wherein the first plurality of nodes of the knowledge graph are based on the first plurality of values of the first table and the first plurality of values of the second table, the second plurality of nodes of the knowledge graph are based on the second plurality of values of the first table and the second plurality of values of the second table, the first particular value of the first plurality of values is located on the first table and the second table, the second particular value of the second plurality of values is located on the first table, and the third particular value of the second plurality of values is located on the second table.

A further extension to the method 500 can include detecting in the knowledge graph a first number of node connections between the first particular value of the first plurality of values and the second particular value of the second plurality of values, detecting in the knowledge graph a second number of node connections between the first particular value of the first plurality of values and a third particular value of the second plurality of values, determining the first number of node connections is greater than the second number of node connections, and filling the missing value with the second particular value based on the determining the first particular node is connected to the second particular node as in step 514 and further based on the determining the first number of node connections is greater than the second number of node connections.

Another extension to the method 500 can include detecting in the knowledge graph a first number of node connections between the first particular value of the first plurality of values and the second particular value of the second plurality of values, detecting in the knowledge graph a second number of node connections between the first particular value of the first plurality of values and a third particular value of the second plurality of values, determining a first connection strength based on the first number of node connections, determining a second connection strength based on the second number of node connections, comparing the first connection strength and the second connection strength to determine that the first connection strength is greater than the second connection strength, and filling the missing value with the second particular value based on the determining the first particular node is connected to the second particular node as in step 514 and further based on the determining that the first connection strength is greater than the second connection strength.

In the method 500, the relational database can include a plurality of tables, and the method 500 can further include providing the knowledge graph with a plurality of labels for the first plurality of nodes and the second plurality of nodes, the plurality of labels including indicators of the tables of the first plurality of values and the second plurality of values, detecting a particular label of the plurality of labels indicating a particular table of the plurality of tables, the particular label corresponding to one or both of the first particular value or the second particular value, and filling the missing value with the second particular value in the particular table further based on the particular label indicating the particular table. The plurality of labels can further include indicators of the rows of the first plurality of values and the second plurality of values, the particular label of the plurality of labels can further indicate the particular row, and the filling the missing value with the second particular value in the particular table can be further based on the particular label indicating the particular row.

In an exemplary implementation the one or more tables of the method 500 can include a first table and a second table, each of the first table and the second table including a corresponding first plurality of values and a corresponding second plurality of values, wherein the first plurality of nodes of the knowledge graph are based on the first plurality of values of the first table and the first plurality of values of the second table, and the second plurality of nodes of the knowledge graph are based on the second plurality of values of the first table and the second plurality of values of the second table.

In an application of the method 500, a plurality of network destinations can be monitored via a network, and the first plurality of values and the second plurality of values can be received from the plurality of network destinations. The relational database can be generated based on the first plurality of values and the second plurality of values from the plurality of network destinations. A request can be received from a user via the network for access to the relational database, and responsive to the request, the relational database can be rendered accessible to the user as updated by the filling of the missing value with the second particular value. The first plurality of values can include for instance building identifiers and the second plurality of values can include for instance building addresses.

In another application of the method 500, an industrial process, for example the microprocessor fabrication process described herein, can be performed, and a plurality of process measurements for the industrial process can be performed including the first plurality of values and the second plurality of values. The relational database can be generated based on the first plurality of values and the second plurality of values of the process measurements, and the industrial process can be continued based on the relational database as updated by the filling of the missing value with the second particular value.

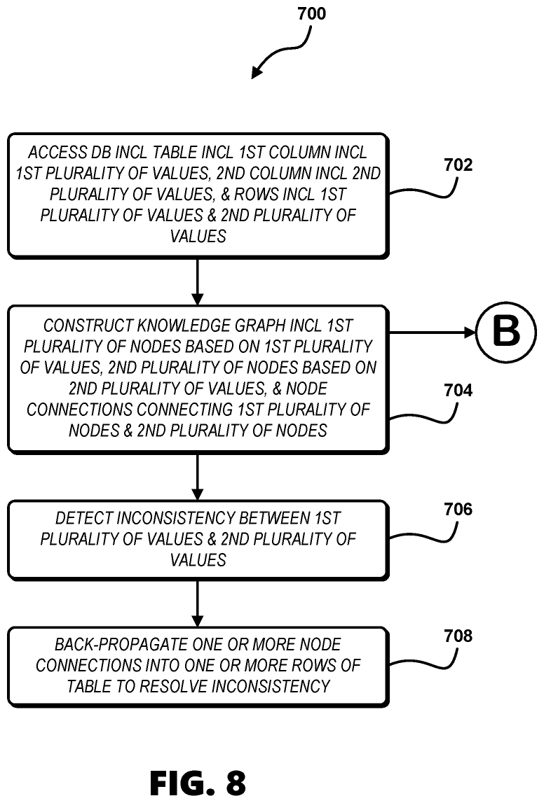

Referring to FIG. 8, a diagram shows a data processing method in the form of a database correction method 700. The database correction method 700 is described with reference to the components of system 10 shown in FIG. 1, and the method 700 can be performed by the data manager 20 via the ingestion engine 22, heuristics engine 24, and augmentation engine 26 of the system 10. Alternatively, the method 700 can be performed via other suitable systems.

A step 702 includes accessing a relational database including one or more tables including a first column including a first plurality of values, a second column including a second plurality of values, and a plurality of rows including the first plurality of values and the second plurality of values. A knowledge graph is constructed including a first plurality of nodes based on the first plurality of values, a second plurality of nodes based on the second plurality of values, and a plurality of node connections connecting the first plurality of nodes and the second plurality of nodes (step 704). An inconsistency is detected between the first plurality of values and the second plurality of values (step 706). One or more of the plurality of node connections of the knowledge graph are back-propagated into one or more of the plurality of rows of the one or more tables of the relational database to resolve the inconsistency between the first plurality of values and the second plurality of values (step 708).

In the knowledge graph each of the first plurality of nodes can include one of the first plurality of values and each of the second plurality of nodes can include one of the second plurality of values, and one or more of the first plurality of nodes corresponding to one or more rows of the one or more tables is connected by a corresponding node connection to a corresponding one of the second plurality of nodes corresponding to the one or more rows to construct the knowledge graph.

In an application of the method 700, a plurality of network destinations can be monitored via a network, and the first plurality of values and the second plurality of values can be received from the plurality of network destinations. The relational database can be generated based on the first plurality of values and the second plurality of values from the plurality of network destinations. A request can be received from a user via the network for access to the relational database, and responsive to the request, the relational database can be rendered accessible to the user as updated by the resolving of the inconsistency between the first plurality of values and the second plurality of values. The first plurality of values can include for instance building identifiers and the second plurality of values can include for instance building addresses.

In another application of the method 700, an industrial process, for example the microprocessor fabrication process described herein, can be performed, and a plurality of process measurements for the industrial process can be performed including the first plurality of values and the second plurality of values. The relational database can be generated based on the first plurality of values and the second plurality of values of the process measurements, and the industrial process can be continued based on the relational database as updated by the resolving of the inconsistency between the first plurality of values and the second plurality of values.

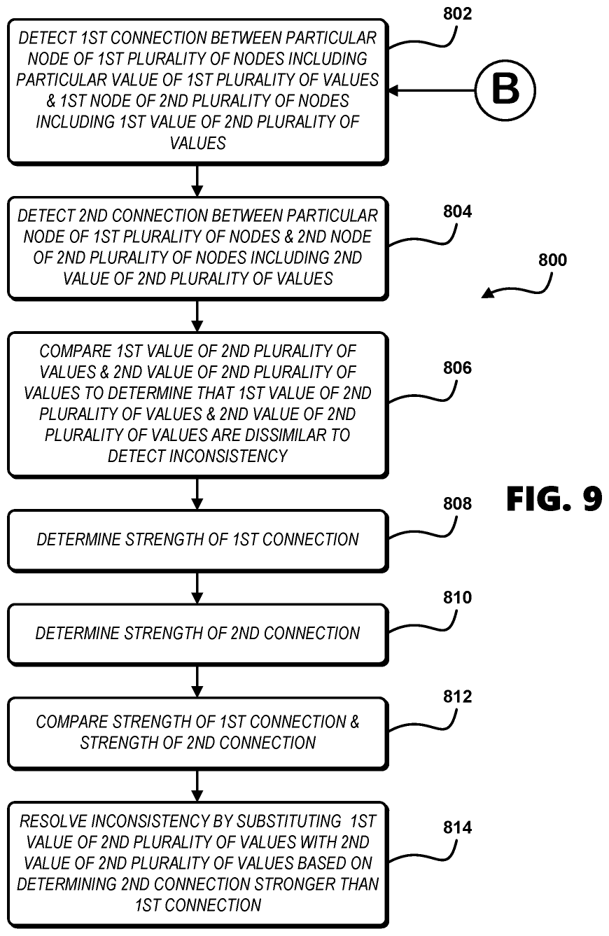

Referring to FIG. 9, an extension 800 to the method 700 continues from step 704 via connector “B” of the method 700. The method extension 800 includes detecting a first connection between a particular node of the first plurality of nodes including a particular value of the first plurality of values and a first node of the second plurality of nodes including a first value of the second plurality of values (step 802), detecting a second connection between the particular node of the first plurality of nodes and a second node of the second plurality of nodes including a second value of the second plurality of values (step 804), and comparing the first value of the second plurality of values and the second value of the second plurality of values to determine that the first value of the second plurality of values and the second value of the second plurality of values are dissimilar to detect the inconsistency (806). The method extension 800 further includes determining a strength of the first connection (step 808), determining a strength of the second connection (step 810), comparing the strength of the first connection and the strength of the second connection to determine that the second connection is stronger than the first connection (step 812), and resolving the inconsistency by substituting the first value of the second plurality of values with the second value of the second plurality of values in the relational database based on the determining that the second connection is stronger than the first connection (step 814). The method extension 800 can further include determining a first number of rows in the relational database supporting the first connection, determining a second number of rows in the relational database supporting the second connection, determining the strength of the first connection based on the first number of rows in the relational database supporting the first connection, and determining the strength of the second connection based on the second number of rows in the relational database supporting the second connection.

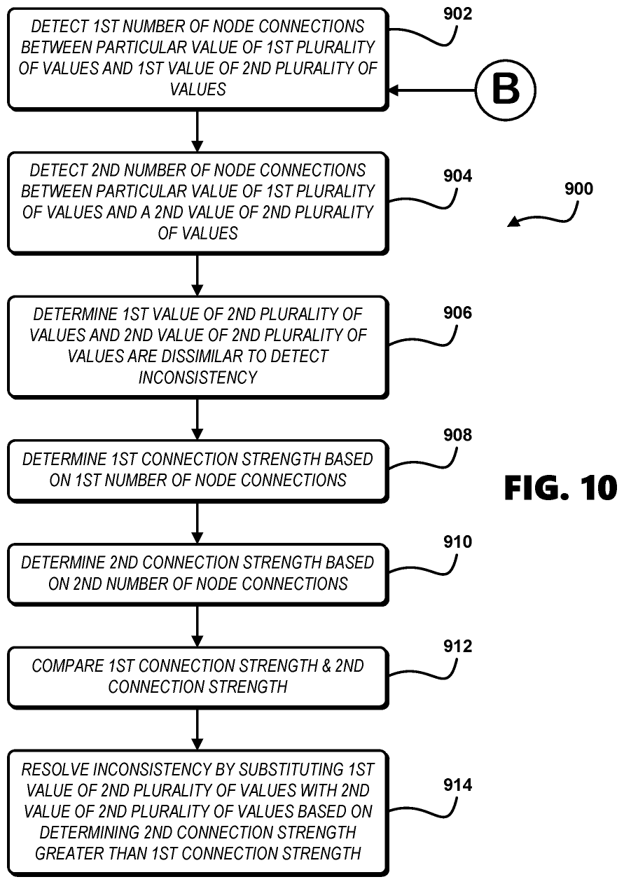

Referring to FIG. 10, an extension 900 to the method 700 continues from step 704 via connector “B” of the method 700. The method extension 900 includes detecting in the knowledge graph a first number of node connections between a particular value of the first plurality of values and a first value of the second plurality of values (step 902), detecting in the knowledge graph a second number of node connections between the particular value of the first plurality of values and a second value of the second plurality of values (step 904), and determining the first value of the second plurality of values and the second value of the second plurality of values are dissimilar to detect the inconsistency (step 906). The method extension 900 further includes determining a first connection strength based on the first number of node connections (step 908), determining a second connection strength based on the second number of node connections (step 910), comparing the first connection strength and the second connection strength to determine that the second connection strength is greater than the first connection strength (step 912), and resolving the inconsistency by substituting the first value of the second plurality of values with the second value of the second plurality of values in the relational database based on the determining that the second connection strength is greater than the first connection strength (step 914). Alternatively, it can be determined that the second number of node connections is greater than the first number of node connections, and the inconsistency can be resolved by substituting the first value of the second plurality of values with the second value of the second plurality of values in the relational database based on the determining that the second number of node connections is greater than the first number of node connections.

The one or more tables of the step 702 can include a first table and a second table, each of the first table and the second table including a corresponding first plurality of values and a corresponding second plurality of values, wherein the first plurality of nodes of the knowledge graph are based on the first plurality of values of the first table and the first plurality of values of the second table, and the second plurality of nodes of the knowledge graph are based on the second plurality of values of the first table and the second plurality of values of the second table. In an extension, the method 700 can further include detecting a first connection between a particular node of the first plurality of nodes including a particular value of the first plurality of values from the first table and the second table and a first node of the second plurality of nodes including a first value of the second plurality of values from the first table, detecting a second connection between the particular node of the first plurality of nodes and a second node of the second plurality of nodes including a second value of the second plurality of values from the second table, and determining that the first value of the second plurality of values and the second value of the second plurality of values are dissimilar to detect the inconsistency. Further, a strength of the first connection can be determined, a strength of the second connection can be determined, the strength of the first connection and the second connection can be compared to determine that the second connection is stronger than the first connection, and the inconsistency can be resolved by substituting the first value of the second plurality of values with the second value of the second plurality of values in the relational database based on the determining that the second connection is stronger than the first connection.

Alternatively, the one or more tables of the step 702 can include a first table, a second table, and a third table, each of the first table, the second table, and the third table including a corresponding first plurality of values and a corresponding second plurality of values wherein the first plurality of nodes of the knowledge graph are based on the first plurality of values of the first table, the first plurality of values of the second table, and the first plurality of values of the third table, and the second plurality of nodes of the knowledge graph are based on the second plurality of values of the first table, the second plurality of values of the second table, and the second plurality of values of the third table. In an extension, the method 700 can further include detecting a first connection between a particular node of the first plurality of nodes including a particular value of the first plurality of values from the first table, the second table, and the third table and a first node of the second plurality of nodes including a first value of the second plurality of values from the first table, and detecting a second connection between the particular node of the first plurality of nodes and a second node of the second plurality of nodes including a second value of the second plurality of values from the second table, and detecting a third connection between the particular node of the first plurality of nodes and a third node of the second plurality of nodes including a third value of the second plurality of values from the third table, and determining that the first value of the second plurality of values is dissimilar to the second value of the second plurality of values and the third value of the second plurality of values to detect the inconsistency. Further, the second value of the second plurality of values and the third value of the second plurality of values can be compared to determine that the second value of the second plurality of values and the third value of the second plurality of values are substantially identical, and the inconsistency can be resolved by substituting the first value of the second plurality of values with the second value of the second plurality of values in the relational database based on the determining that the second value of the second plurality of values and the third value of the second plurality of values are substantially identical and based on the determining that the first value of the second plurality of values is dissimilar to the second value of the second plurality of values and the third value of the second plurality of values.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A data processing method comprising:
accessing a relational database comprising at least one table comprising:
a first column comprising a first plurality of values;
a second column comprising a second plurality of values; and
a plurality of rows comprising the first plurality of values and the second plurality of values;
constructing a knowledge graph comprising a first plurality of nodes based on the first plurality of values, a second plurality of nodes based on the second plurality of values, and a plurality of node connections connecting the first plurality of nodes and the second plurality of nodes;
detecting a missing value in a particular row in the second column in the at least one table in the relational database;
detecting a first particular value of the first plurality of values in the first column in the particular row;
detecting a first particular node corresponding to the first particular value;
determining the first particular node is connected by a first connection to a second particular node corresponding to a second particular value of the second plurality of values; and
filling the missing value with the second particular value based on the determining the first particular node is connected to the second particular node.

2. The method of claim 1, wherein in the knowledge graph each of the first plurality of nodes comprises one of the first plurality of values and each of the second plurality of nodes comprises one of the second plurality of values, and at least one of the first plurality of nodes corresponding to at least one row of the at least one table is connected by a corresponding edge to a corresponding one of the second plurality of nodes corresponding to the at least one row to construct the knowledge graph.

3. The method of claim 1, further comprising:
determining the first particular node is connected by a second connection to a third particular node corresponding to a third particular value of the second plurality of values;
determining a strength of the first connection;
determining a strength of the second connection;
comparing the strength of the first connection and the strength of the second connection to determine that the first connection is stronger than the second connection; and
filling the missing value with the second particular value further based on the determining that the first connection is stronger than the second connection.

4. The method of claim 3, further comprising:
determining a first number of rows in the relational database supporting the first connection;
determining a second number of rows in the relational database supporting the second connection;
determining the strength of the first connection based on the first number of rows in the relational database supporting the first connection; and
determining the strength of the second connection based on the second number of rows in the relational database supporting the second connection.

5. The method of claim 4, the at least one table comprising a first table and a second table, each of the first table and the second table comprising a corresponding first plurality of values and a corresponding second plurality of values, wherein:
the first plurality of nodes of the knowledge graph are based on the first plurality of values of the first table and the first plurality of values of the second table;
the second plurality of nodes of the knowledge graph are based on the second plurality of values of the first table and the second plurality of values of the second table;
the first particular value of the first plurality of values is located on the first table and the second table;
the second particular value of the second plurality of values is located on the first table; and
the third particular value of the second plurality of values is located on the second table.

6. The method of claim 3, further comprising:
determining a first number of rows comprising the first particular value and the second particular value in the relational database;
determining a second number of rows comprising the first particular value and the third particular value in the relational database;
determining the strength of the first connection based on the first number of rows comprising the first particular value and the second particular value in the relational database; and
determining the strength of the second connection based on the second number of rows comprising the first particular value and the third particular value in the relational database.

7. The method of claim 6, the at least one table comprising a first table and a second table, each of the first table and the second table comprising a corresponding first plurality of values and a corresponding second plurality of values, wherein:
the first plurality of nodes of the knowledge graph are based on the first plurality of values of the first table and the first plurality of values of the second table;
the second plurality of nodes of the knowledge graph are based on the second plurality of values of the first table and the second plurality of values of the second table;
the first particular value of the first plurality of values is located on the first table and the second table;
the second particular value of the second plurality of values is located on the first table; and
the third particular value of the second plurality of values is located on the second table.

8. The method of claim 1, further comprising:
detecting in the knowledge graph a first number of node connections between the first particular value of the first plurality of values and the second particular value of the second plurality of values;
detecting in the knowledge graph a second number of node connections between the first particular value of the first plurality of values and a third particular value of the second plurality of values;
determining the first number of node connections is greater than the second number of node connections; and
filling the missing value with the second particular value further based on the determining the first number of node connections is greater than the second number of node connections.

9. The method of claim 1, further comprising:
detecting in the knowledge graph a first number of node connections between the first particular value of the first plurality of values and the second particular value of the second plurality of values;
detecting in the knowledge graph a second number of node connections between the first particular value of the first plurality of values and a third particular value of the second plurality of values;
determining a first connection strength based on the first number of node connections;
determining a second connection strength based on the second number of node connections;
comparing the first connection strength and the second connection strength to determine that the first connection strength is greater than the second connection strength; and
filling the missing value with the second particular value further based on the determining that the first connection strength is greater than the second connection strength.

10. The method of claim 1, wherein the relational database comprises a plurality of tables, the method further comprising:
providing the knowledge graph with a plurality of labels for the first plurality of nodes and the second plurality of nodes, the plurality of labels comprising indicators of the tables of the first plurality of values and the second plurality of values;
detecting a particular label of the plurality of labels indicating a particular table of the plurality of tables, the particular label corresponding to at least one of the first particular value or the second particular value; and
filling the missing value with the second particular value in the particular table further based on the particular label indicating the particular table.

11. The method of claim 10, wherein:
the plurality of labels further comprise indicators of the rows of the first plurality of values and the second plurality of values;
the particular label of the plurality of labels further indicating the particular row; and
the filling the missing value with the second particular value in the particular table is further based on the particular label indicating the particular row.

12. The method of claim 1, the at least one table comprising a first table and a second table, each of the first table and the second table comprising a corresponding first plurality of values and a corresponding second plurality of values, wherein:
the first plurality of nodes of the knowledge graph are based on the first plurality of values of the first table and the first plurality of values of the second table; and
the second plurality of nodes of the knowledge graph are based on the second plurality of values of the first table and the second plurality of values of the second table.

13. The method of claim 1, further comprising:
monitoring a plurality of network destinations via a network;
receiving the first plurality of values and the second plurality of values from the plurality of network destinations;
generating the relational database based on the first plurality of values and the second plurality of values from the plurality of network destinations;
receiving a request from a user via the network for access to the relational database; and
responsive to the request, rendering accessible to the user the relational database as updated by the filling of the missing value with the second particular value.

14. The method of claim 13, the first plurality of values comprising building identifiers and the second plurality of values comprising building addresses.

15. The method of claim 1, further comprising:
performing an industrial process;
performing a plurality of process measurements for the industrial process comprising the first plurality of values and the second plurality of values;
generating the relational database based on the first plurality of values and the second plurality of values of the process measurements; and
continuing the industrial process based on the relational database as updated by the filling of the missing value with the second particular value.

16. A data processing method comprising:
accessing a relational database comprising at least one table comprising:
a first column comprising a first plurality of values;
a second column comprising a second plurality of values; and
a plurality of rows comprising the first plurality of values and the second plurality of values;
constructing a knowledge graph comprising a first plurality of nodes based on the first plurality of values, a second plurality of nodes based on the second plurality of values, and a plurality of node connections connecting the first plurality of nodes and the second plurality of nodes;
detecting an inconsistency between the first plurality of values and the second plurality of values; and
back-propagating at least one of the plurality of node connections of the knowledge graph into at least one of the plurality of rows of the at least one table of the relational database to resolve the inconsistency between the first plurality of values and the second plurality of values.

17. The method of claim 16, wherein in the knowledge graph each of the first plurality of nodes comprises one of the first plurality of values and each of the second plurality of nodes comprises one of the second plurality of values, and at least one of the first plurality of nodes corresponding to at least one row of the at least one table is connected by a corresponding node connection to a corresponding one of the second plurality of nodes corresponding to the at least one row to construct the knowledge graph.

18. The method of claim 16, further comprising:
detecting a first connection between a particular node of the first plurality of nodes comprising a particular value of the first plurality of values and a first node of the second plurality of nodes comprising a first value of the second plurality of values;
detecting a second connection between the particular node of the first plurality of nodes and a second node of the second plurality of nodes comprising a second value of the second plurality of values; and
comparing the first value of the second plurality of values and the second value of the second plurality of values to determine that the first value of the second plurality of values and the second value of the second plurality of values are dissimilar to detect the inconsistency.

19. The method of claim 18, further comprising:
determining a strength of the first connection;
determining a strength of the second connection;
comparing the strength of the first connection and the strength of the second connection to determine that the second connection is stronger than the first connection; and
resolving the inconsistency by substituting the first value of the second plurality of values with the second value of the second plurality of values in the relational database based on the determining that the second connection is stronger than the first connection.

20. The method of claim 19, further comprising:
determining a first number of rows in the relational database supporting the first connection;
determining a second number of rows in the relational database supporting the second connection;
determining the strength of the first connection based on the first number of rows in the relational database supporting the first connection; and
determining the strength of the second connection based on the second number of rows in the relational database supporting the second connection.

21. The method of claim 16, further comprising:
detecting in the knowledge graph a first number of node connections between a particular value of the first plurality of values and a first value of the second plurality of values;
detecting in the knowledge graph a second number of node connections between the particular value of the first plurality of values and a second value of the second plurality of values; and
determining the first value of the second plurality of values and the second value of the second plurality of values are dissimilar to detect the inconsistency.

22. The method of claim 21, further comprising:
determining the second number of node connections is greater than the first number of node connections; and
resolving the inconsistency by substituting the first value of the second plurality of values with the second value of the second plurality of values in the relational database based on the determining that the second number of node connections is greater than the first number of node connections.

23. The method of claim 21, further comprising:
determining a first connection strength based on the first number of node connections;
determining a second connection strength based on the second number of node connections;
comparing the first connection strength and the second connection strength to determine that the second connection strength is greater than the first connection strength; and
resolving the inconsistency by substituting the first value of the second plurality of values with the second value of the second plurality of values in the relational database based on the determining that the second connection strength is greater than the first connection strength.

24. The method of claim 16, the at least one table comprising a first table and a second table, each of the first table and the second table comprising a corresponding first plurality of values and a corresponding second plurality of values, wherein:
the first plurality of nodes of the knowledge graph are based on the first plurality of values of the first table and the first plurality of values of the second table; and
the second plurality of nodes of the knowledge graph are based on the second plurality of values of the first table and the second plurality of values of the second table.

25. The method of claim 24, further comprising:
detecting a first connection between a particular node of the first plurality of nodes comprising a particular value of the first plurality of values from the first table and the second table and a first node of the second plurality of nodes comprising a first value of the second plurality of values from the first table;
detecting a second connection between the particular node of the first plurality of nodes and a second node of the second plurality of nodes comprising a second value of the second plurality of values from the second table; and
determining that the first value of the second plurality of values and the second value of the second plurality of values are dissimilar to detect the inconsistency.

26. The method of claim 25, further comprising:
determining a strength of the first connection;
determining a strength of the second connection;
comparing the strength of the first connection and the second connection to determine that the second connection is stronger than the first connection; and
resolving the inconsistency by substituting the first value of the second plurality of values with the second value of the second plurality of values in the relational database based on the determining that the second connection is stronger than the first connection.

27. The method of claim 16, the at least one table comprising a first table, a second table, and a third table, each of the first table, the second table, and the third table comprising a corresponding first plurality of values and a corresponding second plurality of values wherein:
the first plurality of nodes of the knowledge graph are based on the first plurality of values of the first table, the first plurality of values of the second table, and the first plurality of values of the third table; and
the second plurality of nodes of the knowledge graph are based on the second plurality of values of the first table, the second plurality of values of the second table, and the second plurality of values of the third table.

28. The method of claim 27, further comprising:
detecting a first connection between a particular node of the first plurality of nodes comprising a particular value of the first plurality of values from the first table, the second table, and the third table and a first node of the second plurality of nodes comprising a first value of the second plurality of values from the first table;
detecting a second connection between the particular node of the first plurality of nodes and a second node of the second plurality of nodes comprising a second value of the second plurality of values from the second table;
detecting a third connection between the particular node of the first plurality of nodes and a third node of the second plurality of nodes comprising a third value of the second plurality of values from the third table; and
determining that the first value of the second plurality of values is dissimilar to the second value of the second plurality of values and the third value of the second plurality of values to detect the inconsistency.

29. The method of claim 28, further comprising:
comparing the second value of the second plurality of values and the third value of the second plurality of values to determine that the second value of the second plurality of values and the third value of the second plurality of values are substantially identical; and
resolving the inconsistency by substituting the first value of the second plurality of values with the second value of the second plurality of values in the relational database based on the determining that the second value of the second plurality of values and the third value of the second plurality of values are substantially identical and based on the determining that the first value of the second plurality of values is dissimilar to the second value of the second plurality of values and the third value of the second plurality of values.

30. The method of claim 16, further comprising:
monitoring a plurality of network destinations via a network;
receiving the first plurality of values and the second plurality of values from the plurality of network destinations;
generating the relational database based on the first plurality of values and the second plurality of values from the plurality of network destinations;
receiving a request from a user via the network for access to the relational database; and
responsive to the request, rendering accessible to the user the relational database as updated by the resolving of the inconsistency between the first plurality of values and the second plurality of values.

31. The method of claim 30, the first plurality of values comprising building identifiers and the second plurality of values comprising building addresses.

32. The method of claim 16, further comprising:
performing an industrial process;
performing a plurality of process measurements for the industrial process comprising the first plurality of values and the second plurality of values;
generating the relational database based on the first plurality of values and the second plurality of values of the process measurements; and
continuing the industrial process based on the relational database as updated by the resolving of the inconsistency between the first plurality of values and the second plurality of values.

33. A computing system comprising at least one hardware processor and at least one non-transitory computer-readable storage medium coupled to the at least one hardware processor and storing programming instructions for execution by the at least one hardware processor, wherein the programming instructions, when executed, cause the computing system to perform operations comprising:
accessing a relational database comprising at least one table comprising:
a first column comprising a first plurality of values;
a second column comprising a second plurality of values; and
a plurality of rows comprising the first plurality of values and the second plurality of values; and
constructing a knowledge graph comprising a first plurality of nodes based on the first plurality of values, a second plurality of nodes based on the second plurality of values, and a plurality of node connections connecting the first plurality of nodes and the second plurality of nodes;
detecting an inconsistency between the first plurality of values and the second plurality of values; and
back-propagating at least one of the plurality of node connections of the knowledge graph into at least one of the plurality of rows of the at least one table of the relational database to resolve the inconsistency between the first plurality of values and the second plurality of values.
